(19) United States
(12) Patent Application Publication
(10) Pub. No.: US 2009/0218527 A1
(43) Pub. Date: Sep. 3, 2009

(54) Confocal Microscopy with a Two-Dimensional Array of Light Emitting Diodes

(75) Inventors: Paul Michael William French, West Sussex (GB); Christopher William Dunsby, Bedfordshire (GB); Mark Andrew Aquilla Neil, Oxford (GB)

Correspondence Address: RISSMAN HENDRICKS & OLIVERIO, LLP, 100 Cambridge Street, Suite 2101, BOSTON, MA, 02114, US

(73) Assignee: IMPERIAL INNOVATIONS LIMITED, London (GB)

(21) Appl. No.: 12/295,661

(22) PCT Filed: Mar. 20, 2007
(86) PCT No.: PCT/GB2007/001033

§ 371 Date: Apr. 8, 2009

(30) Foreign Application Priority Data
Apr. 3, 2006 (GB) 0606788.8

(51) Int. Cl. H01J 40/14; G02B 21/06

(52) U.S. Cl. 250/578.1; 359/385

(57) ABSTRACT

A confocal microscope 2 uses as a light source a two-dimensional array of light emitting diodes 4. A two-dimensional array of detector cells 18 in the form of a CCD camera array or a CMOS camera array is provided. A sequence of illumination patterns are generated by the array of light emitting diodes 4. A corresponding sequence of detection patterns are read from the two-dimensional array of detector cells 18. The light emitting diodes may be A1GaInN light emitting diodes generating light in the wavelength 250 nm to 500 nm. The confocal microscope 2 may be fitted to the tip of an endoscope 30.

This invention relates to the field of confocal microscopy.

It is known to provide confocal microscopes for a variety of purposes such as optical sectioning. Confocal microscopy often provides superior image quality, contrast and resolution compared to conventional wide-field microscopy. In wide-field microscopy an image of a sample in the focal plane of an objective is superimposed upon a background of light collected from outside the focal plane. This can result in blurring, which degrades quantitative imaging and the ability to record 3D stacks. Optical sectioning microscopes seek to produce an image of the sample in the focal plane that is not contaminated by light collected from above or below the focal plane. This permits 3D imaging and improved quantification. It also permits potential imaging below the surface of some samples, such as biological tissue. This attribute is particularly useful in applications such as endoscopy.

In a confocal microscope, sectioning is achieved by imaging a point source of illumination/excitation onto a sample in the focal plane of the objective and imaging the resulting recovered light on to a point detector (e.g. a pinhole in front of a photomultiplier). In principle any light from the sample outside of the focal plane will not be efficiently focused on to the point detector. It will be appreciated that this technique requires point-by-point scanning to build up a complete image and so is slower than wide-field imaging. It also requires a scanner to move the point of illumination on the sample and this adds to the complexity of the instrument. Furthermore, a bright light source (usually a laser) is also normally required which adds to the expense.

In order to speed up imaging whilst maintaining optical sectioning, a useful compromise is to illuminate the sample with a line in the focal plane and to image the resulting light returned from the sample onto a line detector (e.g. a slit in front of a multichannel photomultiplier, or an array of point detectors). This type of slit-scanning microscope is produced by Optical Insights LLC of Tucson, Ariz., USA. A problem with this type of slit-scanning microscope is that it still requires a scanning mechanism which is complex, delicate, costly and accordingly disadvantageous.

U.S. Pat. No. 5,587,832 discloses a confocal imaging system in which a light source generates a light pattern of illumination spots by shining through a shutter system. Light detected from the specimen is confined to a pattern corresponding to the pattern of illumination spots by a detector which rejects light beyond the pattern. Image signals are created from the received light. The multiple pattern aperture array for forming the illumination patterns can be formed of ferro electric liquid crystal devices, a digital mirror device or by electrostatic microshutters.

A problem with the system of U.S. Pat. No. 5,587,832 is that a high intensity light source is required to shine through a separate light modulator to create the desired patterns. This is disadvantageous for a number of reasons, such as size, heat generated, cost and the like.

U.S. Pat. No. 6,128,077 discloses a confocal spectral imaging system comprises a light source, a light modulator forming an illumination aperture and directing an illumination pattern to conjugate object locations, and analysing means with a detection aperture, dispersive elements and a detector, wherein the illumination and detection apertures are in conjugate optical planes, and the light modulation consist of an array of light modulator elements, a group of which being arranged according to the illumination pattern and forming the illumination aperture, and are controlled such that the illumination pattern is directed to time-dependent changing conjugate locations of the object. A programmable light source comprises a white light source, dispersion means and a spatial light modulator with an array of individually time-dependent controllable modulator elements being illuminated with the dispersed light and providing a position selective transmittivity or reflectivity, so that a light with a predetermined wavelength distribution passes the light modulator.

U.S. Pat. No. 6,399,935 discloses a confocal optical imaging system comprises light source means, detector means with at least one two-dimensional detector camera, and spatial light modulator means with a first and a second group of modulator elements, wherein the first group of modulator elements is adapted to illuminate an object to be investigated according to a predetermined pattern sequence of illumination spots focused to conjugate locations of the object from which detection light is directed to the detector means for forming a first image I_{c}, and the second group of elements is adapted to illuminate the object at non-conjugate locations and/or to direct detection light from non-conjugate locations of the object to the detector means for forming a second image I_{nc}. In an optical imaging method using this system, the first and second images are collected simultaneously or subsequently.

Viewed from one aspect the present the invention provides a confocal microscope for imaging an object, said confocal microscope comprising: a light source operable to generate a sequence of illumination patterns of illuminating light; a light detector operable to detect light; and an optical system operable to: direct said illuminating light to said object so as to illuminate said object with said sequence of illumination patterns; and direct light from said object to said light detector; wherein said light source comprises: a two-dimensional array of light emitting diodes; and a source array driver operable to drive said two-dimensional array of light emitting diodes to generate said sequence of illumination patterns.

The present invention utilises a two-dimensional array of light emitting diodes as a light source for generating a sequence of illumination patterns or use in a confocal microscope. Such a two-dimensional array of light emitting diodes has many features particularly well suited to the application of confocal microscopy. It is typically small, robust, capable of operating without generating excess heat, low cost and devoid of moving mechanical parts. The two-dimensional array of light emitting diodes is able to produce the desired illumination patterns simply by being driven with appropriate electrical signals. The light emitting diodes are bright and accordingly imaging time can be reduced. Whilst the light emitting diodes are bright, they do not generate an excessive amount of heat or consume a large amount of power thereby considerable extending the range of possible applications of such confocal microscopes. The two-dimensional array may provide individually addressible light emitting diodes or may also be in the form of a set of adjacent one-dimensional arrays of light emitting diodes forming a set of parallel lines of light emitting diodes or simply a linear array of single line LEDs. Such one dimensional arrays allow the possibility of simplified addressing by which all the light emitting diodes of a line are switched together.

Whilst it will be appreciated that the light detector could take a variety of different forms, in preferred embodiments of the invention said light detector comprises: a two-dimensional array of detector cells; and a detector array reader operable to read detected light levels from a sequence of detection patterns of detector cells of said two-dimensional array of detector cells; and said sequence of detection patterns is synchronised with and corresponds to said sequence of illumination patterns.

Using a two-dimensional array of detector cells in this way is advantageously complementary to the two-dimensional array of light emitting diodes used as the light source. The detector array reader is able to electrically control reading of the cells in synchronism with and corresponding to the sequence of illumination patterns generated by the light source. The two-dimensional array of detector cells will accordingly be seen to be “electrically masked” to read only from the desired sequence of detection patterns.

Alignment of confocal microscopes is an important issue. In preferred embodiments of the invention said source array driver and said detector array reader are operable in a calibration mode to illuminate said object with a sequence of calibration patterns and to read said detector cells of said two-dimensional array of detector cells to determine which detector cells from said two-dimensional array of detector cells detect light from which light emitting diodes of said two-dimensional array of light emitting diodes, whereby during imaging with a known illumination pattern those detector cells detecting light from light emitting diodes generating said known illumination pattern are selectively read as part of a corresponding known detection pattern.

The nature of the two-dimensional array of light emitting diodes and the two-dimensional array of detector cells provides a particularly convenient way of calibrating/aligning the confocal microscope in which known illumination patterns are generated for a calibration sample, or a real sample, and the points where the resulting light is most strongly detected can be read from the two-dimensional array of detector cells thereby establishing the register between the illuminating array and the detecting array.

Preferred embodiments of the detector array are a CCD camera array or a CMOS camera array. Such camera arrays are produced with very high levels of resolution and advantageously high reading speeds for purposes other than confocal microscopy and yet can be re-used in this field to a strong advantage. A CMOS camera array will typically allow random access to detector cells allowing only those known to be of interest for a particular illumination pattern to be read out (this gives faster operation). A CCD camera array typically requires full frames to be read, e.g. if 256 line patterns were illuminated, then 256 full frames would be read, but only the values from the detector cells of interest would contribute to the final image. Alternatively, an array CCD camera where single lines of pixels can be read out individually could be employed. A further alternative is a camera structure where individual lines of pixels on the camera can be individually electronically shuttered in synchronism with the illuminating lines so as to build up an image which can then be read out as a single frame.

It will be appreciated that the sequence of illumination patterns could take a wide variety of different forms. However, a preferred compromise between speed of scanning and image quality is achieved when the sequence of illumination patterns comprises patterns formed of one or more lines of illumination. The array of light emitting diodes is well suited to generating this sort of illumination pattern as the array is typically set out in a regular two-dimensional form.

The use of illumination patterns comprising one or more lines of illumination patterns enables line scanning of a target object in a way that can be used to simplify the associated image processing algorithms.

It will be appreciated that the illuminating light could have a wide variety of different wavelengths. The illuminating light and reflected light could be of the same wavelength, or alternatively could be of different wavelengths if techniques such as fluorescence microscopy or fluorescence imaging were being used. In the context of imaging biological samples, as well as being useful in other applications, it is advantageous that the array of light emitting diodes generates an illuminating wavelength in the range 250 nm to 500 nm. Light emitting diodes formed of A1GaInN or other semiconductor material systems are suitable for this purpose. Light of these wavelengths is well suited for imaging tissue by autofluorescence (for label-free imaging of tissues, proteins, e.g. for clinical diagnosis or proteomics).

The degree of miniaturisation permitted by the use of arrays of light emitting diodes to generate the illumination patterns enables many different types of new confocal microscope arrangement to be provided. A particularly preferred application is the use of a confocal microscope on the tip on an endoscope. Such an endoscope is able to be placed up against a tissue to be imaged and the confocal microscope used to generate an image, possibly below the surface, of the tissue concerned and using fluorescence techniques if desired.

The robust and low cost nature of the confocal microscopes achievable using arrays of light emitting diodes enable a variety of other significant uses to be achieved such as surface imaging, e.g. fingerprint scanning. The confocal microscopes could also be used to perform cell-based assays.

Viewed from another aspect the present invention provides a confocal microscope for imaging an object, said confocal microscope comprising: light source means for generating a sequence of illumination patterns of illuminating light; light detector means for detecting light; and optical means for: directing said illuminating light to said object so as to illuminate said object with said sequence of illumination patterns; and directing light from said object to said light detector; wherein said light source means comprises: two-dimensional array means of light emitting diodes; and source array driver means for driving said two-dimensional array means to generate said sequence of illumination patterns.

Viewed from a further aspect the present invention provides a method of performing confocal microscopy to image an object, said method comprising the steps of: generating illuminating light as a sequence of illumination patterns with a light source; detecting light with a light detector; and using an optical system to: direct said illuminating light to said object so as to illuminate said object with said sequence of illumination patterns; and direct light from said object to said light detector; wherein said step of generating comprises driving a two-dimensional array of light emitting diodes to generate said sequence of illumination patterns.

Embodiments of the invention will now be described, by way of example only, with reference to the accompanying drawing in which:

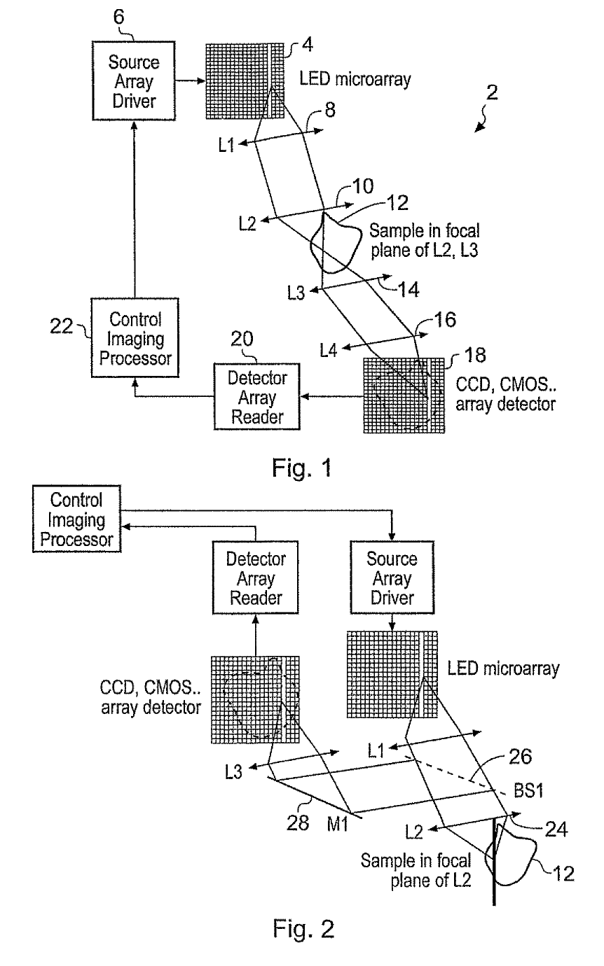

FIG. 1 schematically illustrates a confocal microscope with separate illumination and detection optical paths;

FIG. 2 schematically illustrates a confocal microscope in which the illumination and detection paths are partially combined;

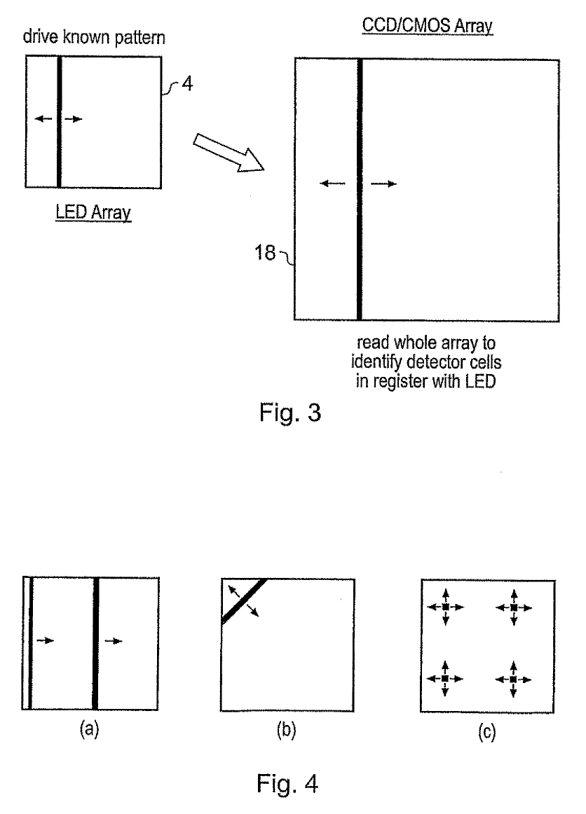

FIG. 3 schematically illustrates the calibration technique which can be used to establish the register between the source array and the detector array;

FIG. 4 schematically illustrates some example illumination patterns;

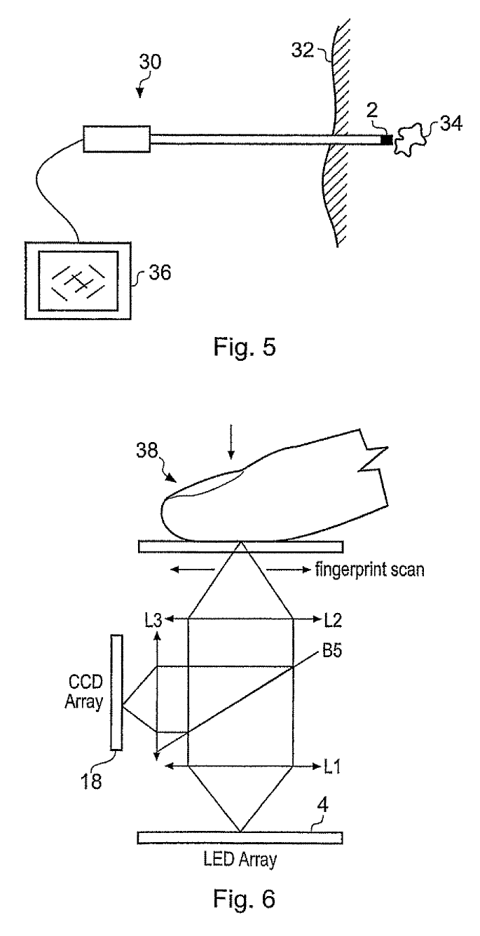

FIG. 5 schematically illustrates the use of a confocal microscope in accordance with the present techniques at the tip of an endoscope;

FIG. 6 schematically illustrates fingerprint scanning;

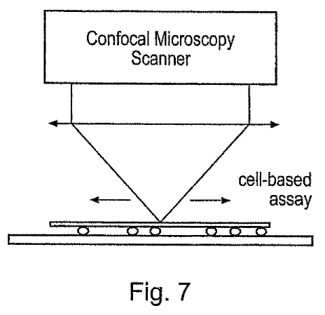

FIG. 7 schematically illustrates a cell-based assay.

FIG. 1 shows a confocal microscope 2 having a light source in the form of a two-dimensional array of light emitting diodes 4 driven by a source array driver circuit 6. The light emitting diodes within the two-dimensional array of light emitting diodes 4 are A1GaInN light emitting diodes capable of emitting illuminating light with a wavelength in the range 250 nm to 500 nm. Light emitting diodes operating in the ultraviolet, visible and near infrared regions could also be used. Other semiconductor material systems could also be used for the light emitting diodes.

The two-dimensional array of light emitting diodes 4 generates a sequence of illumination patterns of illuminating light which passes via lenses 8, 10 to be focused upon a sample object 12, which is in the focal plane of the lens 10. The pattern of light incident upon the object 12 may exactly correspond to the illumination pattern on the two-dimensional array of light emitting diodes 4 or may be altered by the lenses 8, 10 if desired.

Light to be detected from the object 12 is collected by lenses 14 and 16 before being focused on to a two-dimensional array of detector cells 18, such as a CCD camera array or a CMOS camera array. The object 12 is in the focal plane of the lens 14. It will be seen that the lenses 8, 10, 14 and 16 together provide an optical system which directs the illuminating light to the object 12 and directs the light to be detected from the object 12 to the light detector 18.

The light detector 18 is read by a detector array reader circuit 20. This detector array reader circuit 20 is able to selectively read specific detector cells (either pixel-by-pixel or row-by-row) within the two-dimensional array of detector cells 18 which together form detection patterns. These detection patterns provide the masking function equivalent to mechanical pinholes or mechanical slits in known confocal microscopes. As will be seen from FIG. 1, the illumination pattern shown is a single line and the detection pattern is a corresponding single line. This single line is advanced across the two-dimensional array of light emitting diodes 4 to line scan the object 12. Detection patterns being read from the two-dimensional array of detector cells 18 are moved in synchronism with the illumination patterns by the detector array reader circuit 20. A control and imaging processor 22 synchronises the action of the source array driver circuit 6 and detector array reader circuit 20 as well as processing the signals received from the detector cells to generate the final image. This image processing is in accordance with conventional techniques and will not be described further herein.

The detected light and the illuminating light could be of the same wavelength. Alternatively, fluorescence techniques may be used either with fluorescence labels in the object 12 or autofluorescence without such labels (dyes). The detection pattern illustrated in FIG. 1 closely corresponds to the illumination pattern being used. It will be appreciated that the combined action of the optical system 8, 10, 14 and 16 could result in the detection pattern having a different shape to the illumination pattern. However, there is a direct relationship which is fixed by the optical system 8, 10, 14 and 16 between an illumination pattern and a corresponding detection pattern. This fixed relationship will be used by the control and imaging processor 22 in combination with the source array driver circuit 6 and the detector array reader circuit 20 so that appropriate selective illumination and selective detection are performed in accordance with the principles of confocal microscopy and in contrast to typical wide-field imaging.

FIG. 2 illustrates a similar arrangement to that of FIG. 1 except that the optical path is partially shared with a common objective lens 24 being used to focus light on to the object 12 and to recover light from the object 12. A beam splitter 26 and a mirror 28 are used to separate the detection path from the illumination path. It will be appreciated that in the context of the device of FIG. 2, the detected light can have a different wavelength from the illuminating light such that a dichroic mirror can be used as the beam splitter 26. Such differences in wavelength would be normal in fluorescence imaging system and aid in light separation. Other separation techniques could also be used. Combining the use of the objective lens 24 makes the device more compact.

FIG. 3 schematically illustrates a calibration technique which can be used. The array of light emitting diodes 4 is used to drive out a sequence of known illumination patterns. These patterns are returned from either a calibration object or a normal object and give rise to light falling upon the two-dimensional array of detector cells 18. In contrast to the normal imaging use in which only selected detection patterns of detector cells are read to provide the masking effect, in this calibration mode either all the detector cells, or at least a large number of them, are read and the detector cells receiving the highest intensity light determined such that the registration/alignment between the illumination pattern and the corresponding detection pattern can be determined. Once the detection pattern has been determined, then during imaging operation only those detector cells known to lie on that detection pattern line will be read. This process can be repeated for each illumination pattern to be used.

FIG. 4 illustrates three example sequences of illumination patterns. In example (a), two parallel scanning lines are illuminated upon the array of light emitting diodes 4 and advanced across that array to perform line scanning. Providing the two lines are far enough apart, there will be relatively little crosstalk between them and accordingly scanning speed can be increased by the use of multiple lines. Example (b) shows a single scanning line, but in this case advancing diagonally across the array of light emitting diodes 4. Example (c) shows four individual pixels, or small groups of pixels, illuminated at different points on the array of light emitting diodes 4 and moved around that array such that eventually all areas of the object 12 have been illuminated, and with the use of appropriate detection patterns, read.

FIG. 5 schematically illustrates the use of a confocal microscope in accordance with the present techniques in the context of an endoscope. An endoscope 30 with the confocal microscope 2 at its tip is used to view inside a biological sample 32 and image a tissue sample 34. The image is displayed to the user on a display screen 36. In use, the confocal microscope 2 can be placed closely against the tissue sample 34 and an image of the surface of that tissue sample 34 or penetrating into that tissue sample 34 can be generated.

FIG. 6 schematically illustrates the use of the present apparatus for a fingerprint scanning system, which is surface scanning performed on the surface of a finger tip 38. The confocal microscope in this arrangement uses a partially combined optical system. The fingerprint scanning is used to profile the outline of the fingerprint using reflected light or for spectral analysis. Fluorescence techniques can be employed where it is known that different portions of a fingerprint fluoresce in different ways. Autofluorescence can be used for label-free imaging or fluorescent contrast agents used if necessary or desired.

FIG. 7 schematically illustrates the use of the confocal microscope in the context of performing cell-based assays. In this technique, cells within an assay can be imaged, and potentially automatically counted. The confocal microscope is able to image at a range of depths within the assay and accordingly produce a more accurate count.

The compact and low-cost confocal microscope of the present technique could be a read-out device or monitor for many technologies including biochips, microfluidic devices etc. It could also be used for optical biopsy, e.g. to examine lesions to detect skin cancer and other diseases. It may also be useful in profiling surfaces, e.g. for geology or forensic applications. It may also be used in biometrics in general and as the basis for a slit-scanning opthalmoscope.

1. A confocal microscope for imaging an object, said confocal microscope comprising:
a light source comprising a two-dimensional array of light emitting diodes and operable to generate a sequence of illumination patterns of illuminating light;
a light detector operable to detect light;
an optical system operable to:
direct said illuminating light to said object so as to illuminate said object with said sequence of illumination patterns; and
direct light from said object to said light detector; and
a source array driver operable to drive said two-dimensional array of light emitting diodes to generate said sequence of illumination patterns.

2. The confocal microscope as claimed in claim 1, wherein said light detector comprises:
a two-dimensional array of detector cells; and
a detector array reader operable to read detected light levels from a sequence of detection patterns of detector cells of said two-dimensional array of detector cells; wherein
said sequence of detection patterns is synchronized with and corresponds to said sequence of illumination patterns.

3. The confocal microscope as claimed in claim 2,
wherein
said source array driver and said detector array reader are operable in a calibration mode to illuminate said object with a sequence of calibration patterns and to read said detector cells of said two-dimensional array of detector cells to determine which detector cells from said two-dimensional array of detector cells detect light from which light emitting diodes of said two-dimensional array of light emitting diodes, whereby
during imaging with a known illumination pattern those detector cells detecting light from light emitting diodes generating said known illumination pattern are selectively read as part of a corresponding known detection pattern.

4. The confocal microscope as claimed in claim 1, wherein said light detector comprises a CCD camera array.

5. The confocal microscope as claimed in claim 1, wherein said light detector comprises a CMOS camera array.

6. The confocal microscope as claimed in claim 2, wherein said light detector comprises a camera having an electronic shutter circuit operable separately to electronically shutter said sequence of detection patterns of detector cells in synchronism with said sequence of illumination patterns prior to reading of a single frame of image data from said camera.

7. The confocal microscope as claimed in claim 1, wherein said sequence of illumination patterns comprises patterns formed of one or more lines of illumination.

8. The confocal microscope as claimed in claim 7, wherein said sequence of illumination patterns is operable to line scan said object.

9. The confocal microscope as claimed in claim 1, wherein said illuminating light is one of ultraviolet light, visible light or near infrared light.

10. The confocal microscope as claimed in claim 9, wherein said illuminating light has a wavelength in a range of 250 nm to 500 nm.

11. The confocal microscope as claimed in claim 9, wherein said two-dimensional array of light emitting diodes comprises AlGaInN light emitting diodes.

12. The confocal microscope as claimed in claim 1, wherein said light detected by said light detector has a different wavelength from said illuminating light.

13. The confocal microscope as claimed in claim 12, wherein said light source and said light detector are configured to perform fluorescence imaging.

14. The confocal microscope as claimed in claim 1, wherein said two-dimensional array of light emitting diodes, said optical system and at least a portion of said light detector upon which light from said object is incident are located together at a tip of an endoscope.

15. The confocal microscope as claimed in claim 1, wherein said light source and said light detector are configured to perform surface imaging.

16. The confocal microscope as claimed in claim 15, wherein said light source and said light detector are configured to perform fingerprint scanning.

17. The confocal microscope as claimed in claim 1, wherein said light source and said light detector are configured to perform cell-based assays.

18. A confocal microscope for imaging an object, said confocal microscope comprising:
light source means comprising a two-dimensional array means of light emitting diodes for generating a sequence of illumination patterns of illuminating light;
light detector means for detecting light;
optical means for:
directing said illuminating light to said object so as to illuminate said object with said sequence of illumination patterns and
directing light from said object to said light detector; and
source array driver means for driving said two-dimensional array means to generate said sequence of illumination patterns.

19. A method of performing confocal microscopy to image an object, said method comprising the steps of:
driving a two-dimensional array of light emitting diodes for generating illuminating light as a sequence of illumination patterns;
directing said illuminating light through an optical system as to illuminate said object with said sequence of illumination patterns; and
directing light from said object to a light detector.
